(19) United States
(12) Patent Application Publication
(10) Pub. No.: US 2010/0287056 A1
(43) Pub. Date: Nov. 11, 2010

(54) USING CONCEPTS FOR AD TARGETING

(76) Inventors: Ross KONINGSTEIN, Menlo Park, CA (US); Valentin Spitkovsky, Sunnyvale, CA (US); Georges R. Harik, Mountain View, CA (US); Noam Shazeer, Palo Alto, CA (US)

Correspondence Address: STRAUB & POKOTYLO, 788 Shrewsbury Avenue, TINTON FALLS, NJ, 07724, US

(21) Appl. No.: 12/837,883

(22) Filed: Jul. 16, 2010

Related U.S. Application Data
(62) Division of application No. 10/721,010, filed on Nov. 24, 2003.

(51) Int. Cl. G06Q 30/00

(52) U.S. Cl. 705/14.73

(57) ABSTRACT

Concept similarity may be used to help resolve ambiguities with respect to ads served using, at least, keyword targeting. More specifically, concept similarity may be used to help determine ad relevancy and/or ad scores.

### RELATED APPLICATIONS

This is a divisional application of U.S. patent application Ser. No. 10/721,010 (referred to as “the '010 application” and incorporated herein by reference), titled “USING CONCEPTS FOR AD TARGETING,” filed on Nov. 24, 2003 and listing Ross KONINGSTEIN, Valentin SPITKOVSKY, Georges R. HARIK and Noam SHAZEER as the inventors.

### 1. BACKGROUND OF THE INVENTION

1.Field of the Invention

The present invention concerns advertising. In particular, the present invention concerns the targeted serving and rendering of ads.

2. Related Art

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste

Recently, advertising over more interactive media has become popular. For example, as the number of people using the Internet has exploded, advertisers have come to appreciate media and services offered over the Internet as a potentially powerful way to advertise.

Advertisers have developed several strategies in an attempt to maximize the value of such advertising. In one strategy, advertisers use popular presences or means for providing interactive media or services (referred to as “Web sites” in the specification without loss of generality) as conduits to reach a large audience. Using this first approach, an advertiser may place ads on the home page of the New York Times Web site, or the USA Today Web site, for example. In another strategy, an advertiser may attempt to target its ads to more narrow niche audiences, thereby increasing the likelihood of a positive response by the audience. For example, an agency promoting tourism in the Costa Rican rainforest might place ads on the ecotourism-travel subdirectory of the Yahoo Web site. An advertiser will normally determine such targeting manually.

Regardless of the strategy, Web site-based ads (also referred to as “Web ads”) are typically presented to their advertising audience in the form of “banner ads”—i.e., a rectangular box that includes graphic components When a member of the advertising audience (referred to as a “viewer” or “user” in the Specification without loss of generality) selects one of these banner ads by clicking on it, embedded hypertext links typically direct the viewer to the advertiser's Web site. This process, wherein the viewer selects an ad, is commonly referred to as a “click-through” (“Click-through” is intended to cover any user selection.). The ratio of the number of click-throughs to the number of impressions of the ad (i.e., the number of times an ad is displayed) is commonly referred to as the “click-through rate” of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's web page, and consummates a purchase there before leaving that web page. Alternatively, a conversion may be defined as a user being shown an ad, and making a purchase on the advertiser's web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, etc. Often, if user actions don't indicate a consummated purchase, they may indicate a sales lead, although user actions constituting a conversion are not limited to this. Indeed, many other definitions of what constitutes a conversion are possible. The ratio of the number of conversions to the number of impressions of the ad (i.e., the number of times an ad is displayed) is commonly referred to as the conversion rate. If a conversion is defined to be able to occur within a predetermined time since the serving of an ad, one possible definition of the conversion rate might only consider ads that have been served more than the predetermined time in the past.

Despite the initial promise of Web site-based advertisement, there remain several problems with existing approaches. Although advertisers are able to reach a large audience, they are frequently dissatisfied with the return on their advertisement investment.

Similarly, the hosts of Web sites on which the ads are presented (referred to as “Web site hosts” or “ad consumers”) have the challenge of maximizing ad revenue without impairing their users' experience Some Web site hosts have chosen to place advertising revenues over the interests of users. One such Web site is “Overture.com”, which hosts a so-called “search engine” service returning advertisements masquerading as “search results” in response to user queries. The Overture com web site permits advertisers to pay to position an ad for their Web site (or a target Web site) higher up on the list of purported search results. If such schemes where the advertiser only pays if a user clicks on the ad (i.e., cost-per-click) are implemented, the advertiser lacks incentive to target their ads effectively, since a poorly targeted ad will not be clicked and therefore will not require payment Consequently, high cost-per-click ads show up near or at the top, but do not necessarily translate into real revenue for the ad publisher because viewers don't click on them. Furthermore, ads that viewers would click on are further down the list, or not on the list at all, and so relevancy of ads is compromised.

Search engines, such as Google for example, have enabled advertisers to target their ads so that they will be rendered with a search results page and so that they will be relevant, presumably, to the query that prompted the search results page.

Other targeted advertising systems, such as those that target ads based on e-mail information (See, e.g., the systems described in U.S. patent application Ser. No. 10/452,830 (incorporated herein by reference), titled “SERVING ADVERTISEMENTS USING INFORMATION ASSOCIATED WITH E-MAIL”, filed on Jun. 2, 2003 and listing Jeffrey A. Dean, Georges R. Harik and Paul Bucheit as inventors.); or those that target ads based on content (See, e.g., U.S. patent application Ser. No. 10/375,900 (incorporated herein by reference), titled “SERVING ADVERTISEMENTS BASED ON CONTENT”, filed on Feb. 26, 2003 and listing Darrell Anderson, Paul Bucheit, Alex Carobus, Claire Cui, Jeffrey A. Dean, Georges R. Harik, Deepak Jindal, and Narayanan Shivakumar as inventors.) may have similar challenges. That is, advertising systems would like to present advertisements that are relevant to the user requested information in general, and related to the current user interest in particular.

Regardless of whether relevant ads are served with search result documents, content documents, or e-mail, in advertising systems in which keywords are used for targeting, advertisers frequently want to “own” words or phrases. In the context of an ad server for determining ads to be rendered in association with search results for example, in such cases, to garner as wide a reach as possible, advertisers do not want to restrict their ad targeting to exact keyword matches. By not using exact match keyword targeting, the advertiser's ad is shown as frequently as possible when searches contain “their” word(s).

The downside to this approach is that if their ad is shown for all searches containing “their” specified word(s), the search query and search results can often be irrelevant to the ad This often occurs if a query (or some other request) or even just a part of a query has alternative interpretations. As an example, consider an automobile manufacturer that wants their ad to appear for the term “ford”. Showing their ad every time the term “ford” appears in the search terms will often produce relevant ads when the search term is exactly “ford”, or contains “ford mustang” The ad, however, will be shown in connection with search result documents generated in response to queries including the search terms “gerald ford,” “betty ford clinic,” “harrison ford,” “ford agency,” “patricia ford,” etc. Although search result pages afford advertisers a great opportunity to target their ads to a more receptive audience, some queries may have alternative interpretations. As another example, the query term “jaguar” could refer to the car by that name, the animal by that name, the NFL football team by that name, etc. If the user is interested in the animal, then the user might not be interested in search results which pertain to the car or NFL football team. Similarly, the user might not be interested in advertisements, targeted to the keyword “Jaguar,” but that pertain to the car or NFL football team.

One way for advertisers to avoid the serving of their ads with an irrelevant search results document (or some other document) is for the advertiser to specify negative keywords which, if included in a search query, will preclude the serving of their ads. Unfortunately, the effective use of negative keywords requires advertiser effort and foresight.

In view of the foregoing, there is a need for a simple way for an advertiser to indicate ad targeting keyword(s) that they want to “own”, but that avoids the serving of the ads, using such targeting keyword(s), with documents (such as search result documents) that are not relevant to their ad.

### SUMMARY OF THE INVENTION

The present invention helps resolve ambiguities with respect to ads served using, at least, keyword targeting, for example. The present invention may do so by using concept similarity to help determine ad relevancy and/or ad scores.

### BRIEF DESCRIPTION OF THE DRAWINGS

FIG. 1 is a high-level diagram showing parties or entities that can interact with an advertising system.

FIG. 2 illustrates an environment in which advertisers can target their ads on search results pages generated by a search engine, documents served by content servers, and/or e-mail.

FIG. 3 is a high-level block diagram of apparatus that may be used to perform at least some of the various operations that may be used and store at least some of the information that may be used and/or generated in a manner consistent with the present invention.

FIG. 4 is a bubble diagram of operations that may be performed, and information that may be generated, used, and/or stored, to generate concept representations and use such concept representations in concept similarity determinations, in a manner consistent with the present invention.

FIG. 5 is a flow diagram of an exemplary method that may be used to score a similarity of concepts, in a manner consistent with the present invention.

FIG. 6 is a flow diagram of an exemplary method that may be used to determine a similarity of concepts, in a manner consistent with the present invention.

FIGS. 7 and 8 are flow diagrams of exemplary methods that may be used to determine ad concept targeting information, in a manner consistent with the present invention.

FIG. 9 is a flow diagram of an exemplary method that may be used to determine one or more concepts of a request, in a manner consistent with the present invention.

FIGS. 10A-12C are diagrams illustrating examples of operations of exemplary embodiments of the present invention

FIG. 13 is a bubble chart illustrating concept performance information, and its management.

FIG. 14 is a flow diagram of an exemplary method that may be used to manage concept performance information, in a manner consistent with the present invention.

### DETAILED DESCRIPTION

The present invention may involve novel methods, apparatus, message formats and/or data structures for resolving ambiguities with respect to ads served using, at least, keyword targeting for example, so that more relevant, and therefore more useful, ads can be served. The following description is presented to enable one skilled in the art to make and use the invention, and is provided in the context of particular applications and their requirements Various modifications to the disclosed embodiments will be apparent to those skilled in the art, and the general principles set forth below may be applied to other embodiments and applications. Thus, the present invention is not intended to be limited to the embodiments shown and the inventors regard their invention as any patentable subject matter described.

In the following, environments in which, or with which, the present invention may operate are described in § 4.1. Then, exemplary embodiments of the present invention are described in § 4.2. Examples of operations are provided in § 4.3. Finally, some conclusions regarding the present invention are set forth in § 4.4.

Environments in Which, or with Which, the Present Invention May Operate
Exemplary Advertising Environment

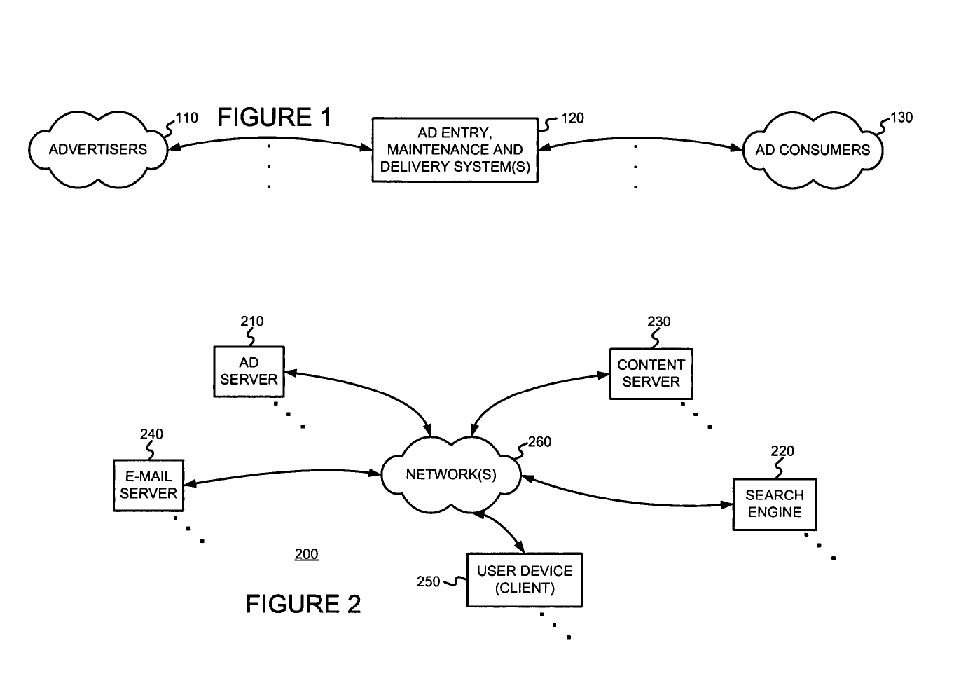

FIG. 1 is a high level diagram of an advertising environment. The environment may include an ad entry, maintenance and delivery system (simply referred to an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or click-through related to the ad occurred) to the system 120 This usage information may include measured or observed user behavior related to ads that have been served.

The ad server 120 may be similar to the one described in FIG. 2 of U.S. patent application Ser. No. 10/375,900, mentioned in § 1.2 above. An advertising program may include information concerning accounts, campaigns, creatives, targeting, etc. The term “account” relates to information for a given advertiser (e.g., a unique e-mail address, a password, billing information, etc.), A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line The campaign for its automotive line have one or more ad groups, each containing one or more ads. Each ad group may include targeting information (e.g., a set of keywords, a set of one or more topics, etc.), and price information (e.g., maximum cost (cost per click-though, cost per conversion, etc.)). Alternatively, or in addition, each ad group may include an average cost (e.g., average cost per click-through, average cost per conversion, etc.). Therefore, a single maximum cost and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server). Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer browser from Microsoft or the Navigator browser from AOL/Time Warner), an e-mail facility (e.g., Outlook from Microsoft), etc. A search engine 220 may permit user devices 250 to search collections of documents (e g., Web pages). A content server 210 may permit user devices 250 to access documents. An e-mail server (e.g., Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220, content provided by the content server 230, and/or e-mail supported by the e-mail server 240 and/or user device e-mail facilities.

Thus, one example of an ad consumer 130 is a general content server 230 that receives requests for documents (e.g., articles, discussion threads, music, video, graphics, search results, Web page listings, etc.,), and retrieves the requested document in response to, or otherwise services, the request. The content server may submit a request for ads to the-ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geolocation information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, click-through or not, impression time, impression date, size, conversion or not, etc.) back to the ad server 120/210. Alternatively, or in addition, such information may be provided back to the ad server 120/210 by some other means.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where, and/or how the ad was to be rendered (e.g., position, click-through or not, impression time, impression date, size, conversion or not, etc.) back to the ad server 120/210. Alternatively, or in addition, such information may be provided back to the ad server 120/210 by some other means.

As discussed in U.S. patent application Ser. No. 10/375,900 (introduced in § 1.2 above), ads targeted to documents served by content servers may also be served.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under, over, or otherwise in association with an e-mail.

### DEFINITIONS

Online ads, such as those used in the exemplary systems described above with reference to FIGS. 1 and 2, or any other system, may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a page on which the ad was served, a search query or search results associated with the serving of the ad, a user characteristic (e.g., their geographic location, the language used by the user, the type of browser used, previous page views, previous behavior), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc As another example, in some systems, an advertiser may specify that its ad is to be served only if a page or search query includes certain keywords or phrases, though, as alluded to above, the present invention obviates the need for an advertiser to enter targeting keywords. As yet another example, in some systems, an advertiser may specify that its ad is to be served only if a document being served includes certain topics or concepts, or falls under a particular cluster or clusters, or some other classification or classifications.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

A “document” is to be broadly interpreted to include any machine-readable and machine-storable work product. A document may be a file, a combination of files, one or more files with embedded links to other files, etc.; the files may be of any type, such as text, audio, image, video, etc. Parts of a document to be rendered to an end user can be thought of as “content” of the document A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page Web pages often include content and may include embedded information (such as meta information, hyperlinks, etc.) and/or embedded instructions (such as Javascript, etc.). In many cases, a document has a unique, addressable, storage location and can therefore be uniquely identified by this addressable location. A universal resource locator (URL) is a unique address used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer or Netscape), a media player (e.g., an MP3 player, a Realnetworks streaming audio file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary.

“User information” may include user behavior information and/or user profile information, such as that described in U.S. patent application Ser. No. 10/452,791 (incorporated herein by reference), entitled “SERVING ADVERTISEMENTS USING USER REQUEST INFORMATION AND USER INFORMATION,” filed on the Jun. 3, 2003, and listing Steve Lawrence, Mehran Sahami and Amit Singhal as inventors.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

A “concept” is a representation of meaning that can be determined from a word and/or by analyzing a sequence of word searches and/or actions as the result of word searches Keywords can have zero or more associated concepts, and each of the associated concepts can have a rating (e.g., a score). Concepts can be associated with one or more other concepts, each with a rating (e.g., a score). Examples of concepts include (a) open directory project (“ODP”) categories, (b) clusters (such as phil clusters described in U.S. Provisional Application Ser. No. 60/416,144 (incorporated herein by reference), titled “Methods and Apparatus for Probabilistic Hierarchical Inferential Learner” filed on Oct. 3, 2002), context information, (such as semantic context vectors described in U.S. patent application Ser. No. 10/419,692 (incorporated herein by reference), titled “DETERMINING CONTEXTUAL INFORMATION FOR ADVERTISEMENTS AND USING SUCH DETERMINED CONTEXTUAL INFORMATION TO SUGGEST TARGETING CRITERIA AND/OR IN THE SERVING OF ADVERTISEMENTS,” filed on Apr. 21, 2003, and listing Amit Singhal, Mehran Sahami, Amit Patel and Steve Lawrence as inventors), etc

Various exemplary embodiments of the present invention are now described in § 4.2.

### Exemplary Embodiments

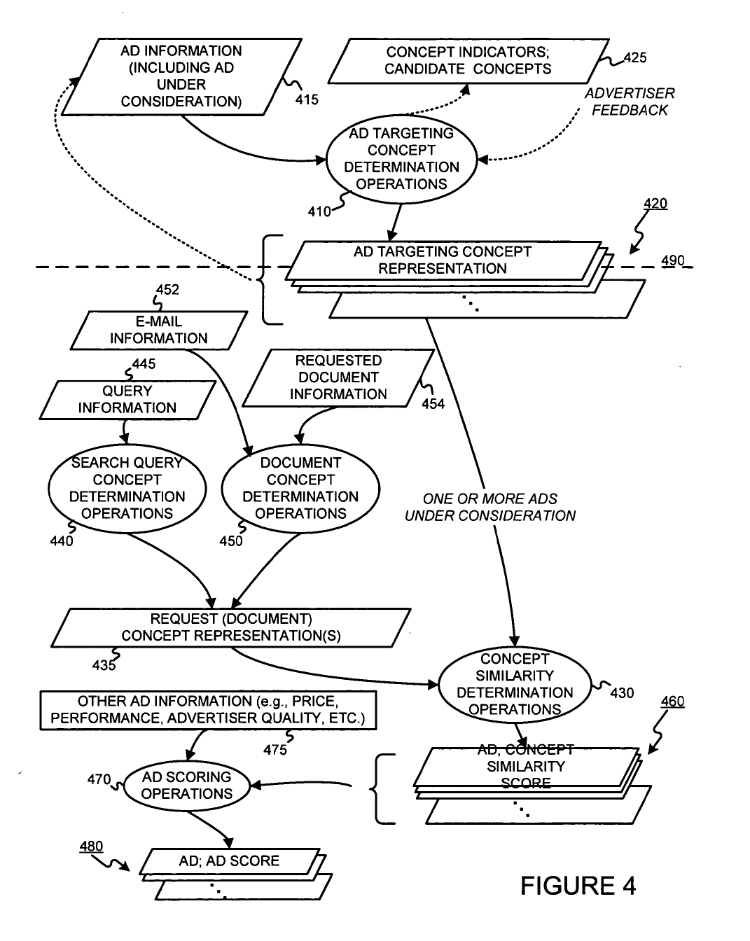

The present invention may use at least one or more ad targeting concepts to (a) determine or help determine whether of not an ad is eligible to be served (e.g., in association with a particular document), and/or (b) determine or help determine a score of an ad. The present invention may do so by determining, for a number of candidate ads, a similarity of an ad targeting concept representation and a request and/or document concept representation. Exemplary techniques for doing this are described in § 4.2.1 below. The similarity determination presumes that ads have associated concepts and requests and/or documents have associated concepts. The present invention also describes techniques for generating representations of such targeting concepts and concepts. Such techniques are described in § 4.2.2 below. Both phases—concept representation generation and concept similarity determination—are introduced below with reference to FIG. 4.

FIG. 4 is a bubble diagram of operations that may be performed, and information that may be generated, used, and/or stored, to generate concept representations and use such concept representations in concept similarity determinations, in a manner consistent with the present invention. Items at and above dashed line 490 concern generating concept representations used to target ads. Items at and below dashed line 490 concern concept similarity determination.

Ad targeting concept determination operations 410 use at least ad information 415, including information about the ad under consideration, to generate one or more ad targeting concept representations 420 for the ad under consideration. The one or more concepts corresponding to the set of one or more ad targeting concept representations 420, or information upon which these concepts were determined, may have been presented to the advertiser as candidate concept indicators/candidate concepts 425 so that the advertiser could approve (either explicitly or implicitly) of one or more concepts to be used to target its ad, or indicate whether some concept indicator is relevant to its ad.

For one or more ads under consideration (e.g., to be served in association with a document), concept similarity determination operations 430 use each of one or more ad targeting concept representation, as well as a request (or requested document) concept representation 435, to determine a concept similarity score 460 for each of the one or more ads under consideration. If the document with which the ad might be served is a search result document, the request/requested document concept representation 435 may have been generated by search query concept determination operations 440 using query information 445 for example. If the document with which the ad might be served is a content document (e.g., an e-mail), the request/requested document concept representation 435 may have been generated by document concept determination operations 450 using information about the requested document 454 (e.g., e-mail information 452).

Ad scoring operations 470 may use at least the concept similarity score(s) 460 for each of one or more ads to determine ad scores 480 for each of the one or more ads. The ad scoring operations 470 may also use other ad information (such as ad price information, ad performance information, and/or advertiser quality information, etc.) in its determination of ad scores 480.

In one embodiment of the present invention, operation 430 is performed in real-time, while other operations may be performed (though are not necessarily performed) ahead of time.
Ad Eligibility Determination and/or Scoring Using Concepts

As introduced above with reference to FIG. 4, once ad targeting concept representations 420 are available, they may be used to determine concept similarity 460 with a request/requested document concept representation 435. Exemplary techniques for determining concept similarity are described in § 4.2.1.1 below.
Exemplary Concept Similarity Determination

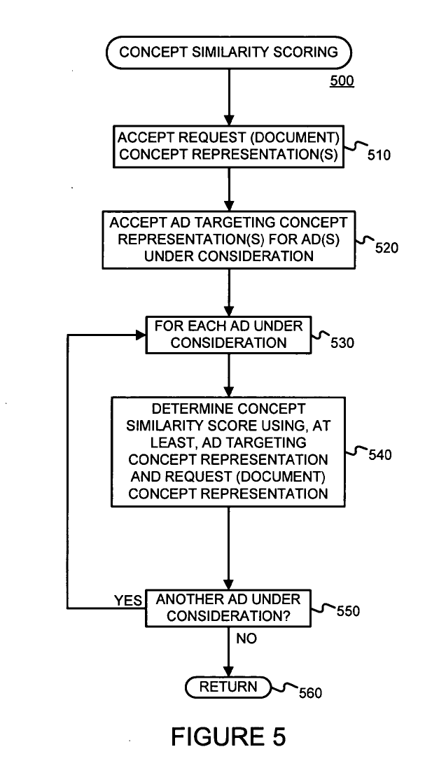

FIG. 5 is a flow diagram of an exemplary method 500 that may be used to score a similarity of concepts in a manner consistent with the present invention. Request/requested document concept representation(s) are accepted (Block 510), as are ad targeting concept representation(s) for each of one or more ads under consideration (Block 520). As indicated by loop 530-550, for each of the one or more ads under consideration, a concept similarity score is determined. (Block 540) This determination may use, at least, the accepted ad targeting concept representation(s) and the request/requested document concept representation(s), Once each of the one or more ads under consideration has been processed, the method 500 is left. (Node 560)

Once the method 500 has been performed, ads under consideration can be included or excluded from consideration for serving using at least the determined concept similarity. Alternatively, or in addition, ads under consideration can be scored (and ranked) using at least the determined concept similarity. Thus, for example, when matching an incoming search with potential ads, where the keyword targeting criteria match, the concept similarities can be used to determine if the ad is relevant for scoring and ranking ad results, and/or determining whether to include or exclude the ad. When used in scoring an ad, the concept can be used with one or more of (a) ad performance information, (b) ad price information, (c) advertiser quality information, and (d) IR score, etc.

Referring back to block 540, recall that an ad can have more than one targeting concept. Similarly, a request/requested document can have, and often will have, more than one concept. In this case, similarity may be determined using a vector scoring method, such as that introduced in § 4.2.1.1.1 below.

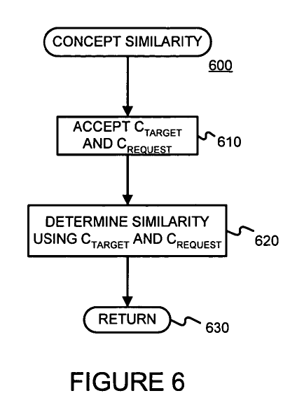

Still referring to block 540, concept similarity can be determined in a number of ways. An exemplary technique for determining concept similarity where the concept representations are vectors is described in § 4.2.1.1.1 below with reference to FIG. 6.
Concept Similarity Using Concept Vectors

FIG. 6 is a flow diagram of an exemplary method 600 that may be used to determine a similarity of concepts in a manner consistent with the present invention. In this method 600, an ad targeting concept vector (C_{TARGET}) and a request/requested document concept vector (C_{REQUEST}) are accepted (Block 610) and used to determine a similarity (Block 620) before the method 600 is left (Node 630).

The concepts associated with the ad targeting criteria may be represented by vector C_{TARGET}. Each of the elements of this vector may identify a concept and a score (e.g., on the scale of—1 to 1)

In the example where ads are to be served with search results, the request (search query) can be augmented with concepts determined from the keywords, order, grouping (e.g., as defined by quotations), capitalization and punctuation, language preference, origin of query, query property (e.g., google.com, google.nl), etc., the search results of the search query, as well as the search history (or some other user information) of the user that submitted the query. In one particular embodiment of the present invention, ad performance on transitory queries (ones frequently refined) can be compared with ad performance on terminal queries (where end users generally choose a search result, rather than refining and/or changing) their query. In such an embodiment, it may be assumed that refined queries that change meaning will yield a poor concept score.

In one embodiment, the concepts associated with the request/requested document are represented by vector C_{REQUEST}. Each of the elements of this vector identify a concept, and a score (e.g., on the scale of—1 to 1).

For concept vectors with independent terms, a similarity score S can be computed from the dot product of concept vectors C_{TARGET} and C_{REQUEST} using the following:

S=Limit-to-unity{K*(C_{TARGET}*C_{REQUEST})/sqrt(||C_{TARGET}||*||C_{REQUEST})}

The magnitude of this similarity score S reflects strength of the match. “K” is a scaling factor that may be adjusted to get a reasonable graduation of scores in the range of 0-1. This may be necessary for thresholding (for inclusion) to be effective. In the vector cross product, strong correlations and strong anti-correlations tend to cancel each other out. The square root may be some other power.

For concept vectors with non-independent terms (e.g. special “graph” relationships such as hierarchies (e.g., ODP), or general semantic graphs (e.g., phil clusters)), the non-independence of terms of a concept vector may be considered. In these cases, it may be better to compute the distance (e.g., a difference) between individual concepts of the concept vectors, keeping in mind that relationships can have non-equal ratings for each direction of travel. For example, a distance of concept elements lower in a hierarchy likely has a better quality than a distance of concept elements higher in a hierarchy. In this case, the similarity S may be determined by determining the minimum distance from one concept to another across one or more connections, each with ratings from 0 to 1. This is because when there are dependent terms in the concept vectors, it may make more sense to consider the distance between concepts rather than the dot-product of vectors. Parallel paths may be added, and for each path, serial section's ratings may be multiplied (e.g., multiply by a constant K, and limit the result to 1). Thus, the similarity can be determined using the following:

S=Limit-to-unity{K*traversal_distance}
Ad Concept Targeting Determination

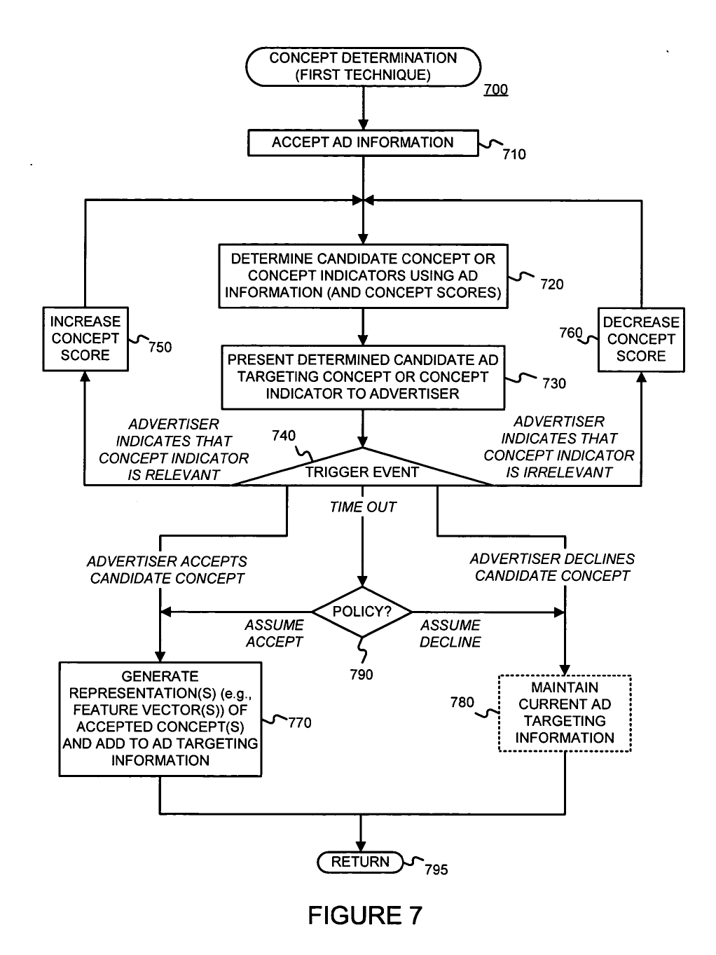

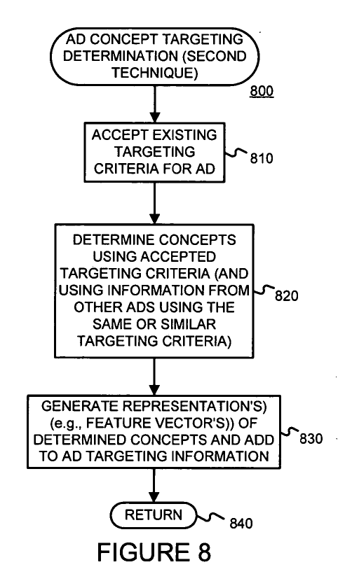

Ad concept targeting can be determined with the help of advertiser feedback, as described with reference to FIG. 7 in § 4.2.2.1, or autonomously, as described with reference to FIG. 8 in § 4.2.2.2.
Concept Determination Using Advertiser Feedback

FIG. 7 is a flow diagram of a first exemplary method 700 that may be used to determine ad concept targeting information, in a manner consistent with the present invention. Ad information is accepted (Block 710) Candidate concept(s) and/or concept indicator(s) are then determined using at least the accepted ad information. (Block 720) If concept scores are available (e.g., after advertiser feedback regarding concept indicators), such scores may also be used in the determination of candidate concept(s) and/or concept indicator(s) The determined candidate ad targeting concept or concept indicator is then presented to the advertiser for feedback. (Block 730)

The operation of the rest of the method 700 depends on advertiser feedback. (Trigger event block 740) For example, if the advertiser indicates that that a presented concept indicator is relevant, the concept indicated by the concept indicator has a score increased (Block 750) and the method 700 continues at block 720. If, on the other hand, the advertiser indicates that a presented concept indicator is irrelevant, the concept indicated by the concept indicator has a score decreased (Block 760) and the method continues at block 720. If the advertiser accepts a candidate concept, a representation of the accepted concept is generated and added to ad targeting information. (Block 770) If, on the other hand, the advertiser declines a candidate concept, the current ad targeting information is maintained. (Block 780) If time expires, a policy may make an assumption of the advertiser's feedback. (Decision block 790) Thus, for example, if a time out occurred without receipt of advertiser feedback, one of acts 770 or 780 (or 750 or 760) could be performed.

Although not shown in FIG. 7, in one embodiment of the present invention if an increased concept score (Recall Block 750.) exceeds a first threshold, the concept can be assumed to be relevant for use as ad targeting information. Conversely, if a decreased concept score (Recall block 700.) falls below a second threshold, the concept can be assumed to be irrelevant and therefore not useful as ad targeting information.

Although exemplary method 700 permits concepts to be obtained by feeding back information (e.g., exemplary searches queries triggering search results with which their ad could be shown) to the advertiser and the advertiser confirming information (e.g., search queries) relevant or irrelevant to their ad, this is a complex user interface and may subject the advertiser to needless unpleasantries. For example, obscure secondary meanings sometimes involve pornography, and in order to mask it out, these keywords and meanings need to be brought to the attention of the advertiser. It may be preferable to analyze the advertiser's other targeting criteria (e.g., making inferences from other advertisers using the same or similar criteria) without requiring advertiser feedback. Such an automated technique would account for hard-to-find dissimilar meanings, while simplifying the advertiser user interface. An exemplary automated technique is described in § 4.2.2.2 below with reference to FIG. 8.
Autonomous Concept Determination

FIG. 8 is a flow diagram of a second exemplary method 800 that may be used to determine ad concept targeting information in a manner consistent with the present invention. Existing targeting criteria for an ad is accepted. (Block 810) One or more concepts are then determined using at least the accepted targeting criteria. (Block 820) The determination of concepts may also use information from other ads using the same or similar targeting criteria. The determination of concepts may also use information from the advertiser's Website, or the “landing page” (such as content, links, etc.) specified by the ad, and/or other information supplied by the advertiser. A representation(s) (e.g., feature vector(s)) of the determined concept(s) is determined and added to the ad targeting information (Block 830) before the method 800 is left (Node 840).
Request Concept Targeting Determination

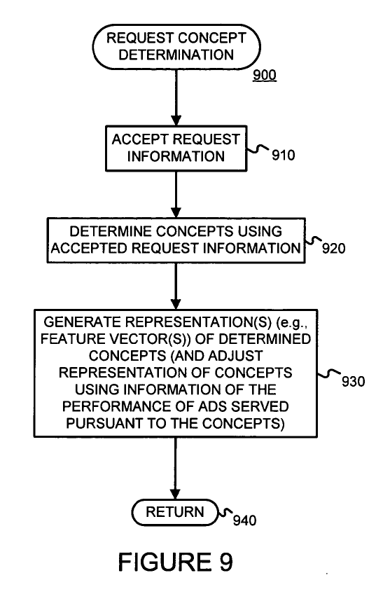

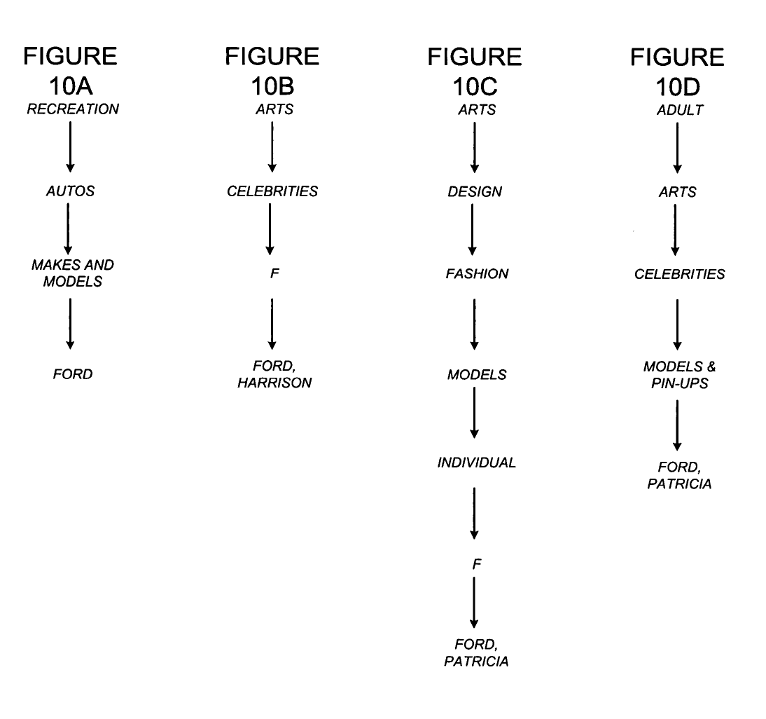

FIG. 9 is a flow diagram of an exemplary method 900 that may be used to determine one or more concepts of a request, in a manner consistent with the present invention. Request information is accepted. (Block 910) One or more concepts are determined using at least the accepted request information. (Block 920) The determination of concepts may also use information about the performance of other concepts from other requests having similar or the same information. A representation(s) of the determined concept(s) is generated (Block 930) and the method 900 is left (Node 940).

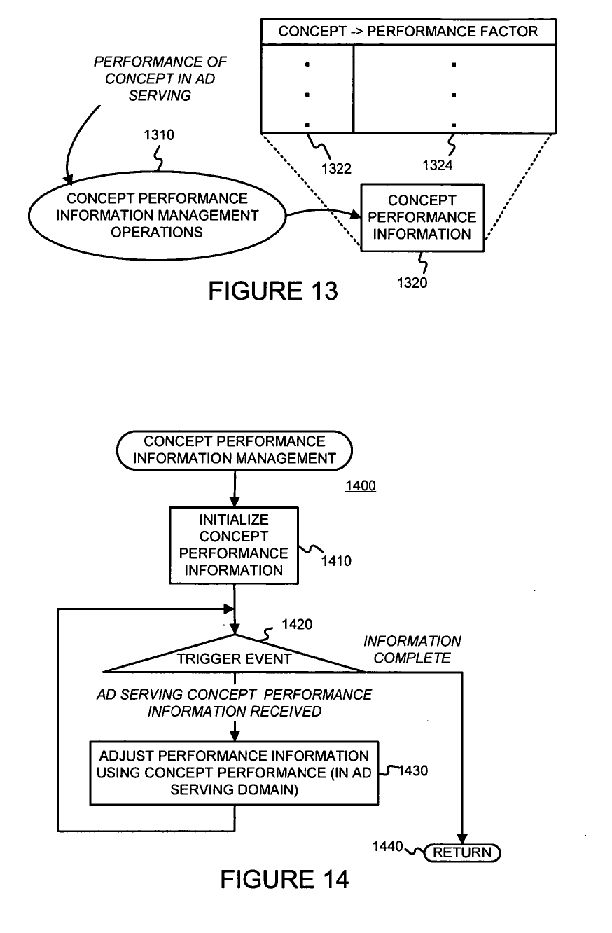

The concepts provided might not fit the needs of advertising in general, or advertising in a particular context (e.g., a syndication partner), well. To improve the quality of concepts, it may be necessary to track statistics about the concepts, or the sources of such concepts, and the results achieved, whether in the form of user clickthroughs, conversions, etc, for ads are served pursuant to the concepts. One embodiment of the present invention tracks such performance and uses it to modify concept scores. FIG. 13 is a bubble chart illustrating the management of such concept performance information. As shown, concept performance information management operations 1310 may accept the performance of concepts in ad serving and may adjust concept performance information 1320 accordingly. The concept performance information may include a number of entries, each including a concept 1322 and at least one performance factor (such as a weight for example) 1324. A performance factor 1324 may be tracked for one or more of (a) a concept source, (b) a concept in general, and (c) a specific keyword-concept relationship. Thus, for example, if an ad is served pursuant to a concept, from a concept source, because of the concept's association with a request keyword, one or more performance indicators of the ad (e.g., click-through, conversion, etc.) may be tracked and used to adjust a performance factor(s) of one or more of (a) the source of the concept (e.g., ODP, a classification technique such as a semantic classification technique for example, etc.), (b) a concept in general (e.g., across all source and/or all keywords), and (c) a keyword-concept relationship (to reflect the fact that the same concept may perform well when used for ad serving based on its association with one keyword, but may perform poorly for another keyword).

Correlating the statistics will provide information over time that will allow the applicability of particular concepts to particular situations to be learned. With this history, when a particular concept source provides concepts, the elements (e.g., concepts) of a concept representation (e.g., a concept vector) can be adjusted by using concept factor(s) learned to determine its relevance to that situation. For example, the adjustment may be performed by multiplying the element with the concept performance factor

FIG. 14 is a flow diagram of an exemplary method 1400 that may be used to perform concept performance information management operations, in a manner consistent with the present invention Concept performance information (e.g., a performance factors 1324 for concepts 1322) is initialized. By default, each performance factor may be set to 1. When ad serving concept performance information is received, the performance information of the concept (e.g., in the ad serving domain) may be adjusting using the received information. (Event block 1420 and block 1430) For example, a performance factor 1324 of a concept 1322 may then be decreased when non-applicable to advertising situations (e.g., as evidenced when the concept has been used to serve ads that don't perform well), and increased when applicable or highly applicable to advertising situations (e.g., as evidenced when the concept has been used to serve ads that perform well).

Note that in some embodiments of the present invention, the performance of “no concept” cases can be tracked as well. For example, suppose an ad was served without using concept matching (e.g., using keywords only) because there was not concept that could be associated with either the keyword(s) or the search term(s). “No concept” can be designated as a special concept and its performance information can be tracked. The “no concept” concept may be provided as an element of the concept vector described above.

The foregoing accounts for the fact that general concept relationships may sometimes be inapplicable to concept relationships in the context of advertising and commerce. For example, the concept “road” may often be related to the term or concept “car” but a user searching for “used car dealers” will probably not be interested in an advertisement for road construction equipment. Consequently, a company selling road construction equipment and targeting its ad(s) to the concept “road” would probably not want its ad(s) served in response to the query “used car dealers.” Thus, the score of a “road” concept might be decreased, particularly if the source was a “car” concept. This aspect of the present invention permits such adjustments to concepts.

Although in FIG. 9 the representation of request concepts can be adjusted using tracked concept performance information, concept performance information may be used alternatively, or in addition, to adjust ad targeting concept representations. (Recall, e.g., 420.) Therefore, it is contemplated that where a number of concepts are used to determine a single similarity score, as was the case with the techniques described above in § 4.2.1.1.1, individual elements of one or both concept vectors are adjusted using the concept performance information before the similarity score is determined.

Adjustments to concept element scores can be carried out in a number of ways. For example, concept element scores may be increased or decreased if the concept performance factor(s) exceed or fall below performance thresholds. Alternatively, or in addition, the adjustment of one concept element score may account for differences of its performances and that of various other concepts. For example, if the performance (e.g., click-through rate) of concept X is twice that of concept Y, a scaling factor adjustment to concept X not only be higher than that of concept Y, but it may be higher as a function of the concepts' performance difference or relationship. Thus, for example, if Y is multiplied by a scaling factor A, X could be multiplied by a scaling factor

$$A \frac{concept X performance}{concept Y performance} ,$$

or some other monotonically increasing function of the relative performances of concepts. As another example of how concept element scores can be adjusted, consider a case in which the concept Z is the “no concept” concept introduced above Concept Z may be a strong contra-indicator for a particular keyword target or search term. In such a case, the performance in the presence of Z may be very low Accordingly, it may have a negative scaling factor (which might cancel out positive contributions from other factors). This may cause ads associated with concept Z to either not show, or to be ranked lower.
Apparatus

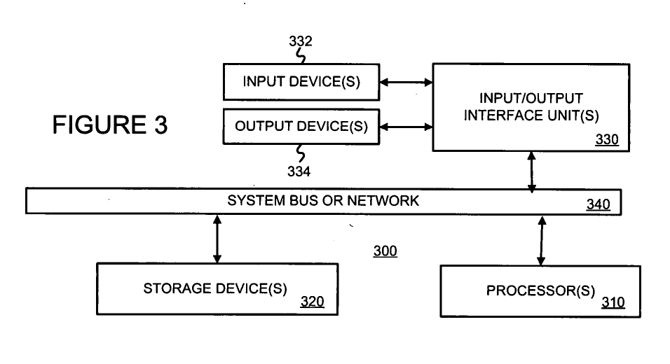

FIG. 3 is high-level block diagram of a machine 300 that may be used to perform one or more of the operations discussed above. The machine 300 basically includes one or more processors 310, one or more input/output interface units 330, one or more storage devices 320, and one or more system buses and/or networks 340 for facilitating the communication of information among the coupled elements. One or more input devices 332 and one or more output devices 334 may be coupled with the one or more input/output interfaces 330.

The one or more processors 310 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 320 and/or may be received from an external source via one or more input interface units 330.

In one embodiment, the machine 300 may be one or more conventional personal computers. In this case, the processing units 310 may be one or more microprocessors. The bus 340 may include a system bus. The storage devices 320 may include system memory, such as read only memory (ROM) and/or random access memory (RAM). The storage devices 320 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 332, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 310 through an appropriate interface 330 coupled to the system bus 340. The output devices 334 may include a monitor or other type of display device, which may also be connected to the system bus 340 via an appropriate interface. In addition to (or instead of) the monitor, the personal computer may include other (peripheral) output devices (not shown), such as speakers and printers for example

The ad server 210, user device (client) 250, search engine 220, content server 230, and/or e-mail server 240 may be implemented as one or more machines 300

Examples of Operations

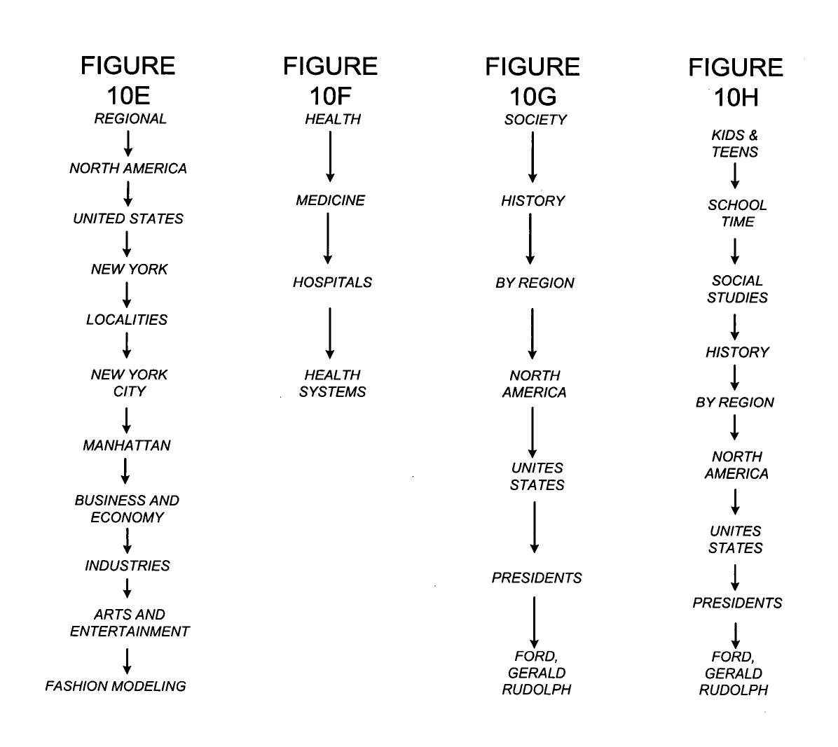

FIGS. 10A-10H illustrate different clusters, determined using ODP, associated with the word “ford”. Thus, as illustrated in FIG. 10A, an ad with targeting keywords “ford,” “car,” “auto,” and “automobile” may have the concepts “recreation,” “autos” and “makes and models.” As illustrated in FIG. 10B, an ad with targeting keywords “ford,” “harrison” and “movies” may have the concepts “arts” and “celebrities.” As illustrated in FIGS. 10C and 10D, an ad with targeting keywords “ford,” and “patricia,” may have the concepts “arts,” “design,” “fashion,” “models,” “individual,” “adult,” “celebrities,” and “models and pin-ups.” As illustrated in FIG. 10E, an ad with targeting keywords “ford” and “agency” may have the concepts “regional,” “north america,” “united states,” “ new york,” “localities,” “new york city,” “ manhattan,” “business and economy,” “industries,” “arts and entertainment,” and “fashion modeling.” As illustrated in FIG. 10F, an ad with targeting keywords “ford” and “betty” and “clinic” and “rehab” may have the concepts “health,” “medicine,” “hospitals,” and “health systems.” Finally, as illustrated in FIGS. 10G and 10H, an ad with the keywords “gerald,” “ford” and “president” may have the concepts “society,” “history,” “by region,” “north america,” “unites states,” “presidents,” “kids and teens,” “school time” and “social studies.”

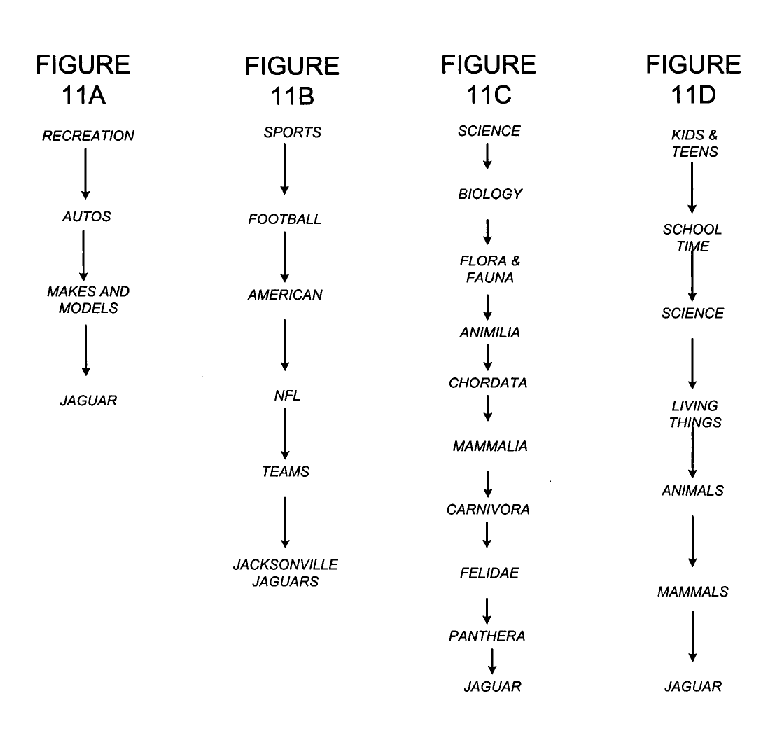

FIGS. 11A-11D illustrate different clusters, determined using ODP, associated with the word “jaguar”. Thus, as illustrated in FIG. 11A, an ad with targeting keywords “jaguar” “car,” “auto,” and “automobile” may have the concepts “recreation,” “autos” and “makes and models.” As illustrated in FIG. 11B, an ad with targeting keywords “jaguars” and “jacksonville” and “nfl” may have the concepts “spots,” “foottball,” “american,” “nfl” and “teams.” Finally, as illustrated in FIGS. 11C and 11D, an ad with targeting keywords “jaguar,” “cat” and “animal” may have the concepts “science,” “biology,” “flora and fauna,” “animilia,” “chordata,” “mammalia,” “carnivora,” “felidae,” “panthera,” “kids and teens,” “school time,” “living things,” “animals” and “mammals.”

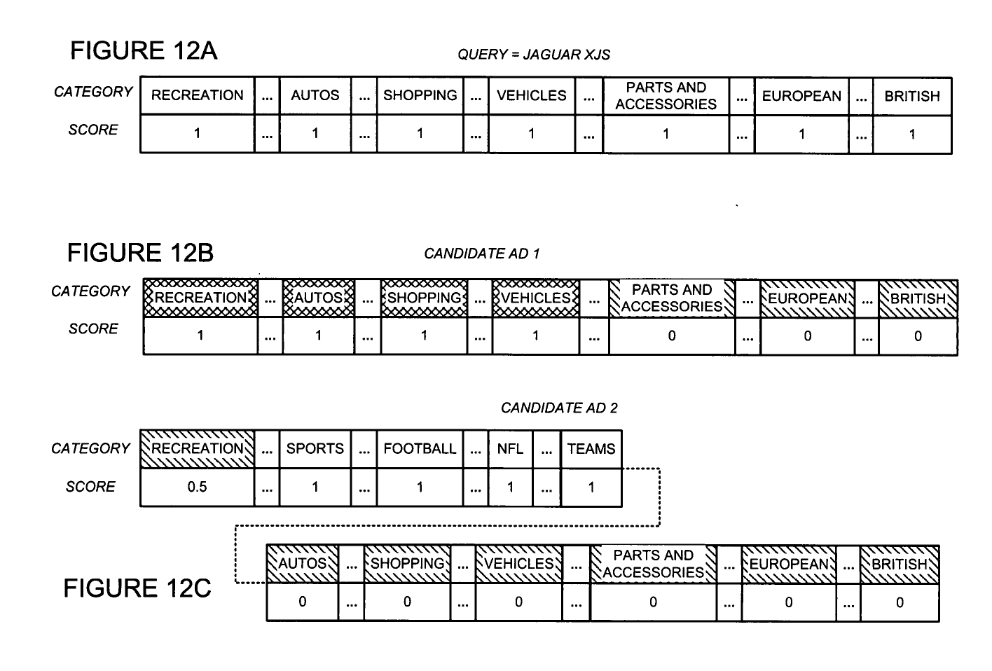

An example of operations in one exemplary embodiment is now described with reference to FIGS. 12A-12C. As shown, the query “jaguar XJS” was submitted to a search engine which requests relevant ads to serve in association with its search results. As shown in FIG. 12A. query is associated with the concepts “recreation,” “autos,” “makes and models,” “shopping,” “vehicles,” “parts and accessories,” “european” and “british” Assume that a first ad has targeting concepts as shown in FIG. 12B while a second ad has targeting concepts as shown in FIG. 12C. The concept similarity score of the query and candidate ad 1 would be higher than that of the query and candidate ad 2.

### CONCLUSIONS

As can be appreciated from the foregoing disclosure, the present invention can be used to help resolve ambiguities with respect to ads served using, at least, keyword targeting. The present invention may do so by using concept similarity to help determine ad relevancy and/or ad scores.

What is claimed is:

1. A computer-implemented method comprising:
a) determining, by an ad serving system including at least one computer on a network, at least one candidate concept of an ad accepted from an advertiser, each of the at least one candidate concepts determined having an ad concept score;
b) presenting, by the ad serving system, the determined at least one candidate concept of the ad to the advertiser;
c) accepting, by the ad serving system, feedback from the advertiser to the presented at least one candidate concept;
d) adjusting, by the ad serving system, the ad concept score associated with the at least one candidate concept using the accepted advertiser feedback;
e) storing, by the ad serving system, the adjusted ad concept score in association with the at least one candidate concept and in association with the ad;
f) determining, by the ad serving system, at least one request concept associated with a received user request, each of the at least one request concepts having an associated request concept score;
g) determining, by the ad serving system, a similarity score between the ad and the received user request using, at least, the at least one candidate concept of the ad and its adjusted ad concept score in combination with the at least one request concept and its request concept score; and
h) controlling, by the ad serving system, serving of the ad using at least the determined similarity score.

2. The computer-implemented method of claim 1 wherein the candidate concept of the ad includes context information, the context information being a representation of meaning that is determined by analyzing a sequence of at least one of (A) word searches or (B) user actions as the result of word searches.

3. The computer-implemented method of claim 1 further comprising:
determining, by the ad serving system, a further candidate concept having an associated score using advertiser feedback; and
presenting, by the ad serving system, the determined further candidate concept to the advertiser.

4. The computer-implemented method of claim 1 wherein the candidate concept is a previously processed search query to which the ad would have been relevant.

5. The computer-implemented method of claim 1 wherein the at least one request concept was determined by:
1) determining, by the ad serving system, at least one request concept having an associated request concept score using the received user request, the at least one request concept including context information, and wherein the request concept score associated with the request concept is determined based on the similarity between the determined request concept and the received user request;
2) generating, by the ad serving system, a representation of the determined at least one request concept, wherein the request concept score associated with the determined at least one request concept in the generated representation is adjusted using performance information of advertisements that have been served pursuant to the request concept; and
3) storing, by the ad serving system, the adjusted value in association with the at least one request concept.

6. The computer-implemented method of claim 5 wherein the performance information is advertisement selection information.

7. The computer-implemented method of claim 5 wherein the performance information is conversion information.

8. The computer-implemented method of claim 5 wherein the performance information of advertisements that have been served pursuant to the request concept used is tracked performance information of advertisements served pursuant to the concept.

9. The computer-implemented method of claim 8 wherein adjusting the request concept score associated with the request concept relative to the request includes increasing the request concept score associated with the request concept relative to the request if the tracked performance information is above a threshold performance level.

10. The computer-implemented method of claim 8 wherein adjusting the request concept score associated with the request concept relative to the request includes decreasing the request concept score associated with the request concept relative to the request if the tracked performance information is below a threshold performance level.

11. The computer-implemented method of claim 8 wherein adjusting the request concept score associated with the request concept relative to the request uses the tracked performance of the request concept relative to tracked performance of at least one other concept

12. The computer-implemented method of claim 8 wherein the performance information is advertisement selection information.

13. The computer-implemented method of claim 8 wherein the performance information is conversion information.

14. A computer-implemented method comprising.
a) determining, by an ad serving system including at least one computer on a network, at least one targeting concept from targeting criteria information associated with an ad, each of the at least one targeting concepts determined having a associated targeting concept score;
b) adjusting, by the ad serving system, the targeting concept score associated with the at least one targeting concept using at least information from other ads using the same or similar targeting criteria information;
c) storing, by the ad serving system, the adjusted targeting concept score in association with the at least one targeting concept and in association with the ad;
d) determining, by the ad serving system, at least one request concept associated with a received user request, each of the at least one request concepts having an associated request concept score;
e) determining, by the ad serving system, a similarity score between the ad and the received user request using, at least, the determined at least one targeting concept of the ad and its adjusted targeting concept score in combination with the at least one request concept and its request concept score; and
f) controlling, by the ad serving system, serving of the ad using at least the determined similarity score.

15. The computer-implemented method of claim 14 wherein the targeting concept includes context information, the context information being a representation of meaning that is determined by analyzing a sequence of at least one of (A) word searches or (B) user actions as the result of word searches.

16. Apparatus comprising:
a) at least one processor;
b) at least one communications interface; and
c) at least one storage device, the storage device storing program instructions which, when executed by the at least one processor, perform a method including:
1) determining at least one candidate concept of an ad accepted from an advertiser, each of the at least one candidate concepts determined having an ad concept score;
2) presenting the determined at least one candidate concept of the ad to the advertiser;
3) accepting feedback from the advertiser to the presented at least one candidate concept;
4) adjusting the ad concept score associated with the at least one candidate concept using the accepted advertiser feedback;
5) storing the adjusted ad concept score in association with the at least one candidate concept and in association with the ad;
6) determining at least one request concept associated with a received user request, each of the at least one request concepts having an associated request concept score;
7) determining a similarity score between the ad and the received user request using, at least, the at least one candidate concept of the ad and its adjusted ad concept score in combination with the at least one request concept and its request concept score; and
8) controlling serving of the ad using at least the determined similarity score.

17. Apparatus comprising:
a) at least one processor;
b) at least one communications interface; and
c) at least one storage device, the storage device storing program instructions which, when executed by the at least one processor, perform a method including:
1) determining at least one targeting concept from targeting criteria information associated with an ad, each of the at least one targeting concepts determined having a associated targeting concept score;
2) adjusting the targeting concept score associated with the at least one targeting concept using at least information from other ads using the same or similar targeting criteria information;
3) storing the adjusted targeting concept score in association with the at least one targeting concept and in association with the ad;
4) determining at least one request concept associated with a received user request, each of the at least one request concepts having an associated request concept score;
5) determining a similarity score between the ad and the received user request using, at least, the determined at least one targeting concept of the ad and its adjusted targeting concept score in combination with the at least one request concept and its request concept score; and
6) controlling serving of the ad using at least the determined similarity score.
